(19) United States
(12) Patent Application Publication
(10) Pub. No.: US 2017/0203684 A1
(43) Pub. Date: Jul. 20, 2017

(54) INTELLIGENT LIGHTING SYSTEM

(71) Applicant: VISION MOTOR SPORTS, INC., Algona, WA (US)

(72) Inventors: Anthony C. GEORGITSIS, Algona, WA (US); Joseph BIRO, Scottsdale, AZ (US); Nicholas B. IRWIN, Algona, WA (US)

(21) Appl. No.: 15/459,814

(22) Filed: Mar. 15, 2017

Related U.S. Application Data
(63) Continuation of application No. PCT/US2015/050198, filed on Sep. 15, 2015.
(60) Provisional application No. 62/050,646, filed on Sep. 15, 2014.

(51) Int. Cl. B60Q 1/26; B60Q 11/00; B60Q 1/00; H05B 33/08

(52) U.S. Cl. CPC B60Q 1/2615; H05B 33/0854; B60Q 1/2611; B60Q 11/005; B60Q 1/0023; H04W 88/02

(57) ABSTRACT

An intelligent lighting system having one or more lighting assemblies containing lighting elements and control boards, and a computing device having a processor and a non-transitory data storage on which is stored computer code which, when executed on the processor, provides functionality to a user for controlling the lighting assemblies and for receiving feedback from the lighting assemblies. The intelligent lighting system may be provided on a vehicle and may contain sensors that collect and transmit to the computing device data regarding various aspects of the performance or environment of the vehicle.

### CROSS REFERENCE TO RELATED APPLICATIONS

This application is a Continuation of co-pending International Patent Application No. PCT/US2015/050198, filed 15 Sep. 2015, which claims the benefit of priority under 35 U.S.C. §119(e) to U.S. Provisional Patent Application No. 62/050,646, filed 15 Sep. 2014. The disclosures set forth in the referenced applications are incorporated herein by reference in their entireties.

### BACKGROUND

The present disclosure relates to systems, components, and methodologies for lighting systems. In particular, the present disclosure is directed to systems, components, and methodologies that allow a user of a lighting system to have enhanced control of the lighting system, and to receive various types of feedback from the lighting system.

### SUMMARY

Illustrative embodiments of the present disclosure provide an intelligent lighting system that is in communication with a software application operating on a computing device, such as a smartphone or tablet. The software application provides a user with enhanced control of the intelligent lighting system, allowing the user to adjust parameters of the intelligent lighting system on demand or based on pre-determined custom programs for the intelligent lighting system.

In illustrative embodiments, control of the intelligent lighting system is enabled by communication links and associated componentry provided on the computing device and on the intelligent lighting system that allows communication according to suitable protocols, such as BLUETOOTH™ or RFID. Where multiple intelligent lighting assemblies are provided as part of a common system, communication may be provided for the intelligent lighting assemblies through mesh networking arrangements, in which communication links are established among the multiple intelligent lighting assemblies.

Illustrative embodiments of the present disclosure also allow the intelligent lighting system to use the communication links to transmit information about the intelligent lighting system's status or about its environment to the software application. The information can then be processed, analyzed, and acted upon by a user of the software application. For example, the intelligent lighting system may be provided as a light bar mounted to a vehicle, and may include sensors to monitor a variety of parameters associated with the lighting elements of the light bar, such as the voltage being applied to the light bar's lighting elements, the number of hours the lighting elements have been in use, and the like. The intelligent lighting system may also include sensors to monitor aspects of the vehicle's performance or the vehicle's environment. Such parameters may include speed or acceleration of the vehicle, humidity or altitude of the vehicle's environment, and the like. Information regarding these parameters may be transmitted to the software application and presented to a user, such that the user can analyze and (if necessary) take action based on the information.

In still other illustrative embodiments, intelligent lighting systems provide operational benefits to a company or organization that maintains a fleet of vehicles, each of which may include one of the disclosed intelligent lighting systems. The intelligent lighting systems can obtain, record, and transmit operational information about the vehicles, such as their performance when using different types of equipment (e.g., tires, shocks, etc.) or when being operated by different drivers. An organization having access to such data provided by the intelligent lighting systems may analyze the data to improve operational decision making.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The present disclosure will be described hereafter with reference to the attached drawings which are given as non-limiting examples only, in which:

FIG. 1 is shows a perspective view of an intelligent lighting system that includes light bar assemblies having lighting elements and control boards mounted onto a vehicle, and a software application in communication with the light bar assemblies;

FIGS. 2a-b show an exemplary light bar assembly having lighting elements and a mounted control board;

FIG. 3 shows a block diagram of a control board of the type depicted in FIG. 1, and having a microcontroller unit, sensors, and modules for providing communication capabilities;

FIG. 4 shows an exemplary control board 400 in accordance with the present disclosure;

FIG. 5 shows an exemplary screen display that may be presented to a user of a software application during a pairing process;

FIG. 6a shows an exemplary screen display that may be presented by a software application to a user for turning lighting elements on or off, and showing an on-screen switch in an off position;

FIG. 6b shows an exemplary screen display that may be presented by a software application to a user for turning lighting elements on or off, and showing an on-screen switch in an on position;

FIGS. 7a-b show a display screen provided by a software application that may be presented to the user having buttons by which the user can select whether the strobe speed of lighting elements should be slow or fast, and a slider by which the user can adjust the brightness of lighting elements;

FIGS. 8a-8b show exemplary screen displays with readings from sensors associated with light bar assemblies that can be provided to a user of a software application;

FIG. 9 shows a screen display that includes on-screen switch 902 indicating that a proximity alert has been activated.

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

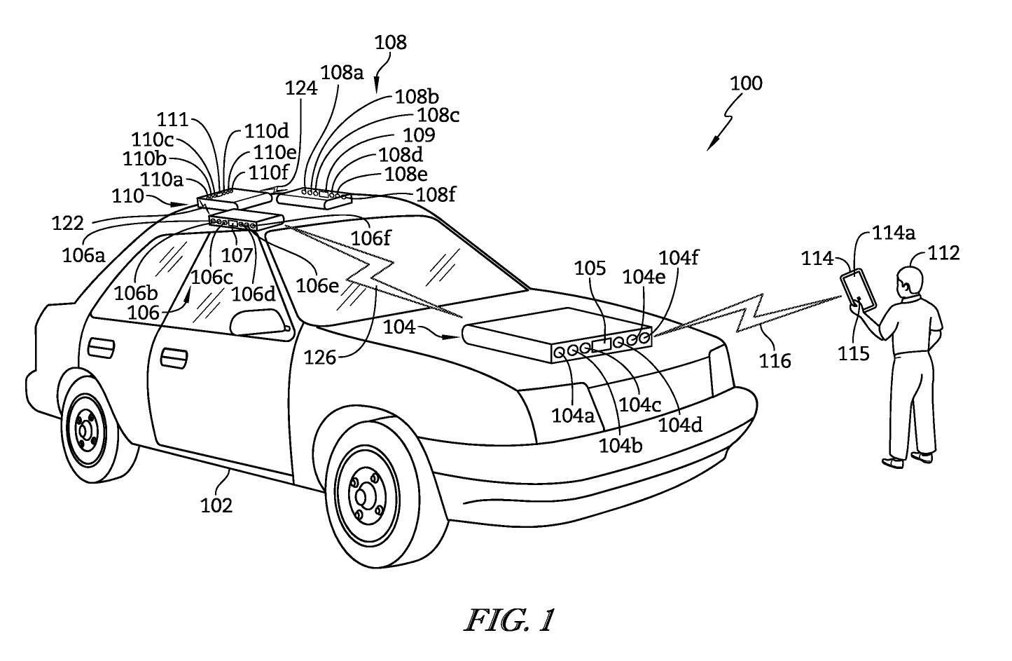

FIG. 1 shows an intelligent lighting system 100 that includes a front light bar assembly 104 mounted to the front of a vehicle 102, peripheral light bar assemblies 106 and 108 mounted to left and right sides, respectively, of vehicle 102, and a rear light bar assembly 110 mounted to the rear of vehicle 102. The intelligent lighting system 100 also includes a software application 115 installed on a computing device 114, which is depicted as being used by a user 112. The software application 115 may be in direct communication with one or more of the light bar assemblies, and in the depicted embodiment is in direct communication with the front light bar assembly 104 via communication link 116.

By way of overview, the intelligent lighting system 100 allows the user 112 to have enhanced control over parameters of the light bar assemblies 104, 106, 108, and 110, including to turn them on or off, adjust their brightness, provide them with predetermined custom programs that govern their operation upon occurrence of certain events, and other aspects that will be described in more detail below. In addition, the intelligent lighting system 100 includes various sensors provided on or near the light bar assemblies 104, 106, 108, and 110 that can monitor and provided feedback on various aspects of the performance or environment of the vehicle 102. Information on such parameters may be transmitted to the software application 115, where it can be synthesized and displayed to the user 112.

In particular, the front light bar assembly 104, peripheral light bar assemblies 106 and 108, and rear light bar assembly 110 are depicted in this illustrative embodiment as linear, light emitting diode (“LED”) light bar assemblies. Such light bar assemblies 104, 106, 108, and 110 may include an outer housing having a relatively compact, linear profile. However, the light bar assemblies 104, 106, 108, and 110 can take on a variety of dimensions depending on the application at hand, the suitability for the object on which the light bar assemblies 104, 106, 108, and 110 will be mounted, or user preferences. Moreover, while linear light bar assemblies 104, 106, 108, and 110 may be suitable for use with vehicles, the intelligent lighting system 100 need not be limited to use with such light bar assemblies, but can include other types of lighting element configurations appropriate for other deployment environments. For example, the intelligent lighting system 100 may be deployed inside or outside commercial or residential buildings.

The light bar assemblies may include internal light-generating elements 104a-f, 106a-f, 108a-f, and 110a-f that, in this illustrative embodiment, are electrically driven LEDs. Use of LEDs 104a-f, 106a-f, 108a-f, and 110a-f are beneficial for their compact size, in-service durability, low power consumption, fast response, and relatively high light output.

Although the front light bar assembly 104, peripheral light bar assemblies 106 and 108, and rear light bar assembly 110 are depicted in certain respective locations on the vehicle 102, these locations are merely exemplary and useful for the present illustrative description. Light bar assemblies positioned in other locations on or near vehicle 102 are within the scope of the present disclosure, including on the hood, trunk, side panels, roof, or other locations.

Each of the depicted light bar assemblies includes a respective control board. In particular, the front light bar assembly 104 includes a control board 105, the peripheral light bar assemblies 106 and 108 include control boards 107 and 109, respectively, and the rear light bar assembly 110 includes a control board 111. The control boards 105 serves numerous functions, as will be described in more detail below. By way of summary, the control board 105 controls and drives the lighting elements 104a-f of the front light bar assembly 104 based on commands provided by a user, collects various types of information about the front light bar assembly 104, collects various types of information about the vehicle 102 and its environment, and maintains a communication link with the computing device 114 such that information can be transmitted between the control board 105 and the software application 115. The control boards 107, 109, and 111 may be similar to the control board 105, but as will be explained below, may also have certain differences allowing them to be manufactured using lower cost components than those used in connection with the control board 105.

Each depicted control board 105, 107, 109, and 111 may be affixed within a respective light bar assembly 104, 106, 108, and 110. For example, the control boards 105, 107, 109, and 111 may be mounted within the respective light bar assemblies 104, 106, 108, and 110 (e.g., through screws), and then covered with a casing or housing that protects the respective light bar assemblies 104, 106, 108, and 110.

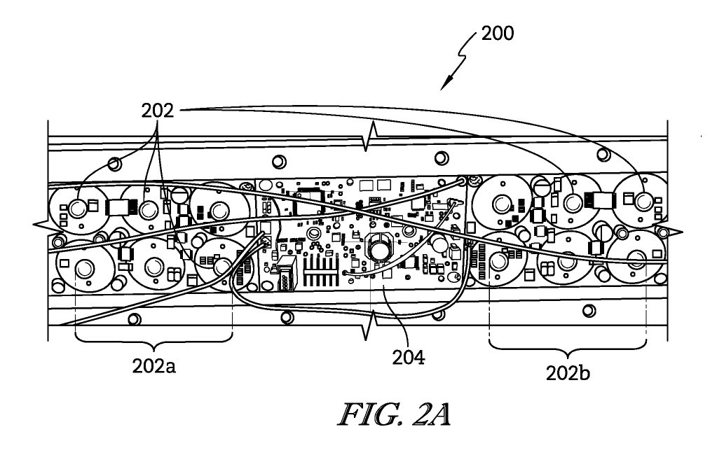

FIGS. 2a-b show an exemplary vehicle light bar 200 having lighting elements 202 and a mounted control board 204. As depicted, the control board 204 is mounted in a location generally between a left group of lighting elements 202a and a right group of lighting elements 202b.

However, returning to FIG. 1, the control boards 105, 107, 109, and 111 may be provided in other locations on or proximate to the vehicle 102. For example, the control board 105 may be located remotely from the front light bar assembly 104 and electrically connected to the light bar assembly 104 through a wire or a communication bus. Similarly, the control boards 107, 109, and 111 may be provided in other locations on or proximate to the vehicle 102.

As previously mentioned, the intelligent lighting system 100 also includes a software application 115 installed on a computing device 114. The computing device 114, in this illustrative embodiment, is a mobile smartphone. In other illustrative embodiments, the computing device 114 may be provided as a tablet, a PDA, a personal computer, a laptop, or the like. When provided as a smartphone, the computing device 114 may be an IPHONE™running Apple's iOS™ line of operating systems, may be a smartphone running the ANDROID™ line of operating systems, the WINDOWS MOBILE™ or WINDOWS PHONE™ line of operating systems, BLACKBERRY™ operating systems, or other operating systems suitable for use in mobile computing devices.

The computing device 114 includes a processor and one or more memories. The software application 115 may be implemented in Java, C, C++, C#, shell scripts, other known programming languages, or combinations thereof. The software application 115 may be compiled and stored onto a memory of the computing device 114. When the software application 115 is invoked by the user 112, it may be loaded onto and executed by the processor. The computing device 114 also includes a display screen 114a that may be a touch screen. The user 112 may be presented with user interfaces on the display screen 114a and may be prompted to make selections through on-screen buttons, sliders, menus, fields, or other user interface elements. The user 112 may make selections on such user interfaces by interacting with the display screen 114a, whose touch sensitive properties allow the user 112 to make such selections. Other suitable forms of user input, such as keyboard input, roller ball input, or stylus input, are also within the scope of the present disclosure.

The computing device 114 may be compliant with the BLUETOOTH™ communication protocol, including in certain embodiments, the BLUETOOTH™ Low Energy (“BLE”) protocol. Thus, the computing device 114 may include modules that implement the BLUETOOTH™ communication stack, including a BLE controller, a transmitter, a receiver, and BLE host software. The BLE controller, transmitter, receiver, and host software may all be provided on one, dedicated, integrated chip having a microcontroller and memory modules. However, other manners of providing BLE functionality are within the scope of the present disclosure. For example, the BLE controller, transmitter, and receiver may be provided on one module, while the software application 115 and the BLE host software are separately stored on system memory and invoked for execution by the processor at appropriate times.

The software application 115 may be in operative communication with the BLE host software of the computing device 114 such that BLUETOOTH™ communications received by the computing device 114 can be retrieved by the software application 115 for processing.

The software application 115 is communicatively coupled to the front light bar 104 through one or more communication links 116. As already suggested, the communication link 116 may be based on BLUETOOTH™ communication, such as the BLE protocol. The communication link 116 may also provide communication using RFID, cellular network communication, wireless local area networking capabilities (i.e., “WiFi”), near field communication (NFC), or other communication protocols and architectures.

In the depicted illustration, the software application 115 has a communication link 116 with only the front light bar assembly 104. As will be explained below, communication with the remaining light bar assemblies 106, 108, and 110 may be provided through mesh networking functionality. In other embodiments, however, the software application 115 may also have communication links with one or more of the other light bar assemblies 106, 108, and 110.

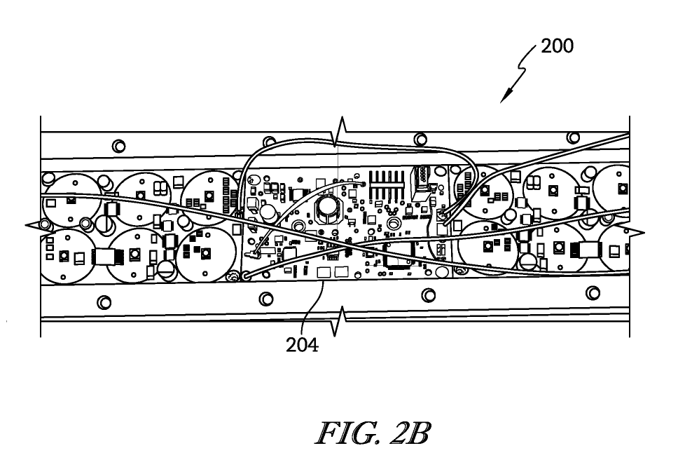

FIG. 3 shows a block diagram 300 of the control board 105, which may be similar to the control boards 107, 109, and 111 depicted in FIG. 1. The control board 105 includes a microcontroller unit 302, a sensor subsystem 303, an RFID/NFC module 304, a BLUETOOTH™ low energy module 306, an LED driver 314, and lighting elements 316. The control board 105 also includes components used for regulation and control of power, voltage, and/or current. Exemplary such components are depicted as a buck converter 310, a power converter 312, and a balun module 308.

The components depicted in FIG. 3 may communicate with one another through a variety of electrical communication methodologies, such as through I2C busses or Serial Peripheral Interface (SPI) busses.

The microcontroller unit 302 provides overall control of the operation of the control board 105. The microcontroller unit 302 includes a processor, one or more memories, and communication interfaces. The microcontroller unit 302 includes program logic that, when executed, provides instruction signals on the operation of the lighting elements 316, including to turn them on or off, to alter their brightness, etc. These instruction signals are transmitted to the LED driver 314, which operates the lighting elements 316 in accordance with the instructions from the microcontroller unit 302.

The program logic implemented by the microcontroller unit 302 may be written and compiled into object code and stored onto a memory (e.g., RAM) of the microcontroller unit 302, from where it may be loaded and executed on the processor of the microcontroller unit 302. The program logic may be written in languages such as C, C++, assembly, or other languages. The microcontroller unit 302 may also include a memory (e.g., a Flash memory) for long term data storage. An exemplary microcontroller unit 302 within the scope of the present disclosure is the STM32F1 Series or STM32F1 Series microcontrollers from STMICROELECTRONICS™ in Geneva, Switzerland.

In addition to executing logic and providing instructions that operate the lighting elements 316, the microcontroller unit 302 also may send signals to the BLUETOOTH™ low energy module 306 or the RFID/NFC module 304 for subsequent transmission to the software application 115. For example, the microcontroller unit 302 receives electronic signals from the sensor subsystem 303 (to be discussed in more detail below). The microcontroller unit 302 may transmit those electronic signals to the software application 115 either as received, or may perform processing on those signals before transmitting them to the software application 115.

The sensor subsystem 303 collects information regarding the performance or environment of the vehicle 102. The sensor subsystem 303 may include a variety of sensor types, and may include microelectromechanical systems (MEMS) sensors 303a-c. Each of the sensors 303a-c may be responsible for sensing a different parameter. For example, in this illustrative embodiment, the sensor 303a may include accelerometers and gyroscopes for sensing acceleration and motion of the control board 105. The sensor 303b may be a temperature sensor to measure the ambient temperature in the environment of the control board 105. The sensor 303c may measure the humidity or moisture near the control board 105. Exemplary MEMS sensors suitable for use in accordance with the present disclosure may include the H3LIS331DL, the LPS25H, and the HTS221 sensors from STMICROELECTRONICS™ in Geneva, Switzerland.

The RFID/NFC module 304 provides the control board 105 with functionality for RFID-based and NFC-based communication. In particular, the RFID/NFC module 304 can operate as an RFID transponder such that nearby RFID scanners can read and identify RFID signals being transmitted by the RFID/NFC module 304. An exemplary component suitable for use as the RFID/NFC module 304 is the NFC/RFID M24LR64E, from STMICROELECTRONICS™ in Geneva, Switzerland. The RFID/NFC module 304 may be used as an RFID tag, such that any given light bar assembly (e.g., the front light bar assembly 104) can be uniquely identified based on detection and recognition of signals transmitted by the RFID/NFC module 304.

The BLUETOOTH™ low energy module 306 allows for transmission and reception of data through wireless signals in accordance with the BLE protocol. There are a variety of ways to implement BLE functionality on the control board 105 within the scope of the present disclosure, and any appropriate implementation that provides BLE compliance may be suitable. For example, the BLUETOOTH™ low energy module 306 may be programmed to implement the Physical Layer and Link Layer functionality of the BLE specification. The microcontroller unit 302 may include program logic that implements the Logical Link Control and Adaptation Protocol (L2CAP) layer, the Attribute Protocol (ATT) layer, the Generic Attribute Profile (GATT) layer, the Security Manager Protocol (SMP) layer, and the Generic Access Profile (GAP) layer of the BLE specification. In other implementations, the BLUETOOTH™ low energy module 306 may implement the entire BLE stack. An exemplary component suitable for use as the BLUETOOTH™ low energy module 306 is the BlueNRG processor, from STMICROELECTRONICS™ in Geneva, Switzerland.

The LED driver 314 provides power that drives the lighting elements 316 and may also provide power regulation and power control functionality. Generally, the LED driver 314 may provide varying quantities of power to the lighting elements 316 as to alter the lighting characteristics of the lighting elements 316 (e.g., turn on, turn off, alter brightness, etc.). The power provided by the LED driver 314 may be based on instructions from the microcontroller unit 302 and conveyed to the LED driver 314 from the microcontroller unit 302. An exemplary LED driver 314 suitable for use in connection with the present disclosure is the MAX16833/MAX16833B-MAX16833D from MAXIM INTEGRATED™ in San Jose, Calif.

The control board 105 may also include other electrical components to facilitate signal transmission among the depicted components. For example, the control board 105 may include one or more converters or regulators. Converters may include AC/DC converters or DC/DC converters. Converters may include buck converters or boost converters. Regulators may include voltage regulators or current regulators. The depicted example shows a buck converter 310 which may be useful to buck voltages as necessary to be suitable for provision to the microcontroller unit 302. An exemplary buck converter 310 suitable for use in connection with the present disclosure is the L7980 regulator from STMICROELECTRONICS™ in Geneva, Switzerland. Also depicted is a voltage regulator 312. An exemplary voltage regulator 312 suitable for use in connection with the present disclosure is the STLQ015XG, from STMICROELECTRONICS™ in Geneva, Switzerland.

The control board 105 may also include transformers. For example, the depicted example includes a balun module 308 for transforming signals received over an antenna (e.g., via the BLUETOOTH™ low energy module 306) for use on the control board 105. An exemplary balun module 308 suitable for use with the present disclosure is the BALF-NRG-01D3 from STMICROELECTRONICS™ in Geneva, Switzerland.

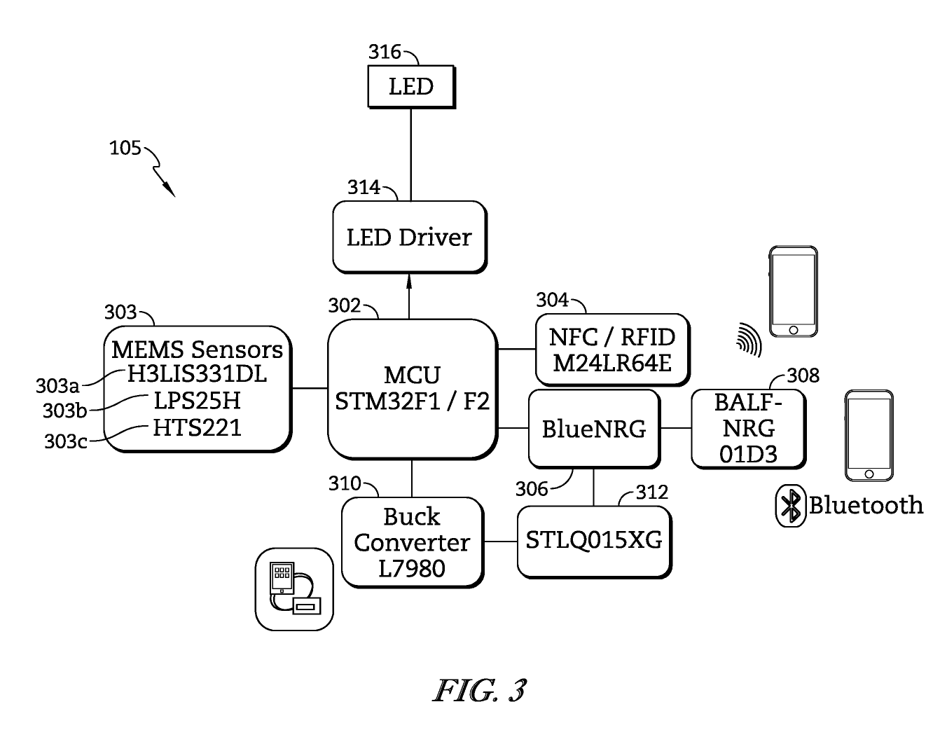

FIG. 4 shows a photograph of an exemplary control board 400 in accordance with the present disclosure.

Returning to FIG. 1, exemplary usage scenarios of the lighting system 106 will be described. According to one aspect of the present disclosure, the intelligent lighting system 106 allows the user 112 to use the software application 115 to control aspects of the front light bar assembly 105, the peripheral light bar assemblies 106 and 108, and the rear light bar assembly 110. To do so, the communication link 116 may be established between the computing device 114 and the control board 105. In operation, the BLUETOOTH™ low energy module 306 on the control board 105 may be activated and may broadcast its availability to engage in BLUETOOTH™ communications with other devices. The computing device 114 may also be activated, and may initiate a pairing process to pair with the BLUETOOTH™ low energy module 306. In accordance with the BLE specification, the pairing process may involve the exchange of pairing request messages, pairing response messages, encrypting the communications link, and exchange of security keys. The pairing process may be a Secure Simple Pairing process. Generally, any and all security and privacy features offered by the BLE specification may be optionally used with the communication link 116.

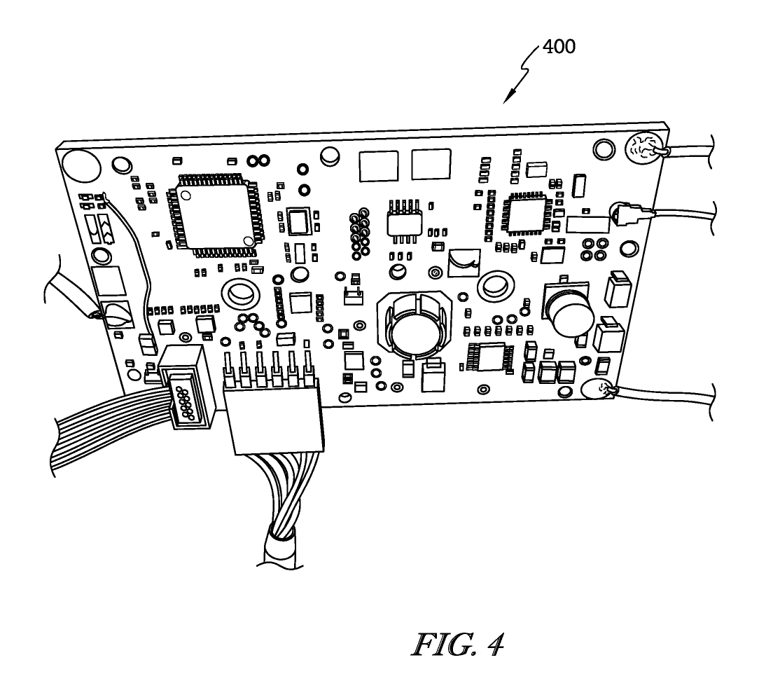

An exemplary screen display 500 that may be presented to a user during a pairing process is shown in FIG. 5.

Once paired, the user 112 may control the lighting elements 104a-f of the front light bar assembly 104 via the software application 115. In particular, the software application 115 on the computing device 114 may expose a user interface to the user 112 via the display screen 114a, which allows the user to select commands and controls regarding the operation of the lighting elements 114a-f. The user 112 may select commands and controls, and the software application 115 may convert those commands and controls into signals that are sent over the communication link 116 in accordance with BLUETOOTH™ specifications.

Upon receipt, the control board 105 may process the signals received over the communication link 116. The signals may be received by the BLUETOOTH™ low energy module 306, processed by the balun module 308 and other converter or regulator components as appropriate, and processed in accordance with BLUETOOTH™ low energy specifications. The signals may then be transmitted to the microcontroller unit 302. Program logic being executed on the microcontroller unit 302 may determine the commands and controls that were issued by the user 112, and issue appropriate signaling to the LED driver 314, which adjusts the lighting elements 104a-f in accordance with the issued commands and controls.

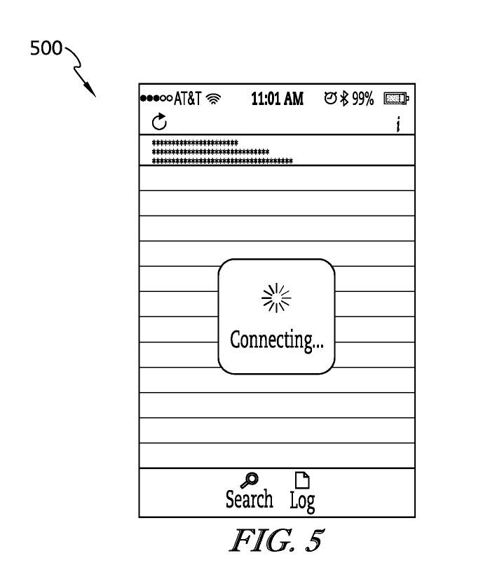

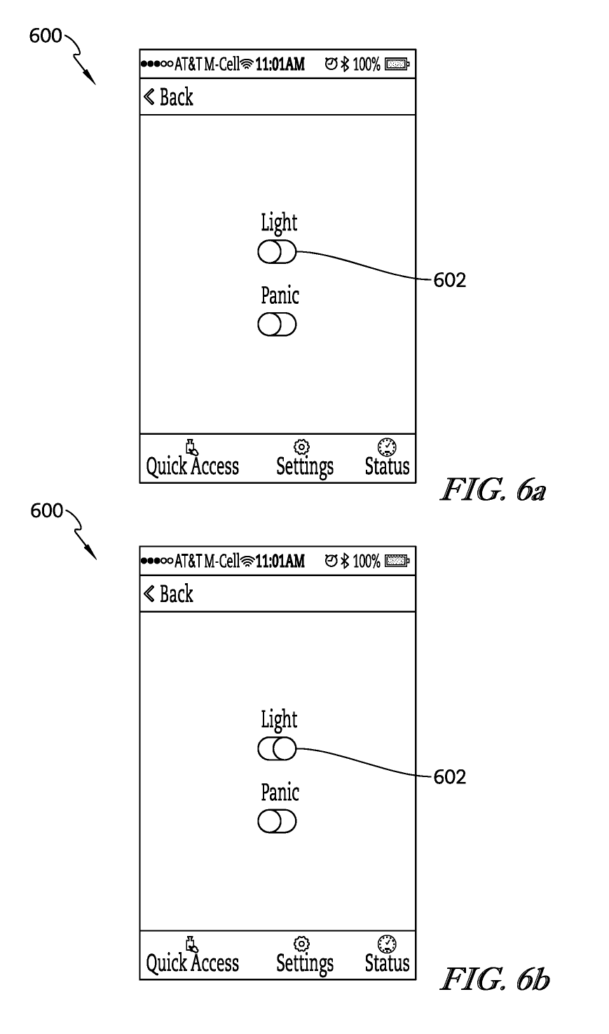

In one exemplary usage scenario, the user 112 may turn the lighting elements 104a-f on or off using commands provided to the software application 115 via the display screen 114a. The user 112 may provide a command to turn the lighting elements 104a-f on or off by sliding a slide switch, selecting a radio button or check box, or other similar user input mechanisms. An exemplary screen display 600 that may be presented by the software application 115 to the user 112 is shown in FIG. 6a, which includes an on-screen switch 602 in an off position. FIG. 6b shows the on-screen switch 602 in an on position.

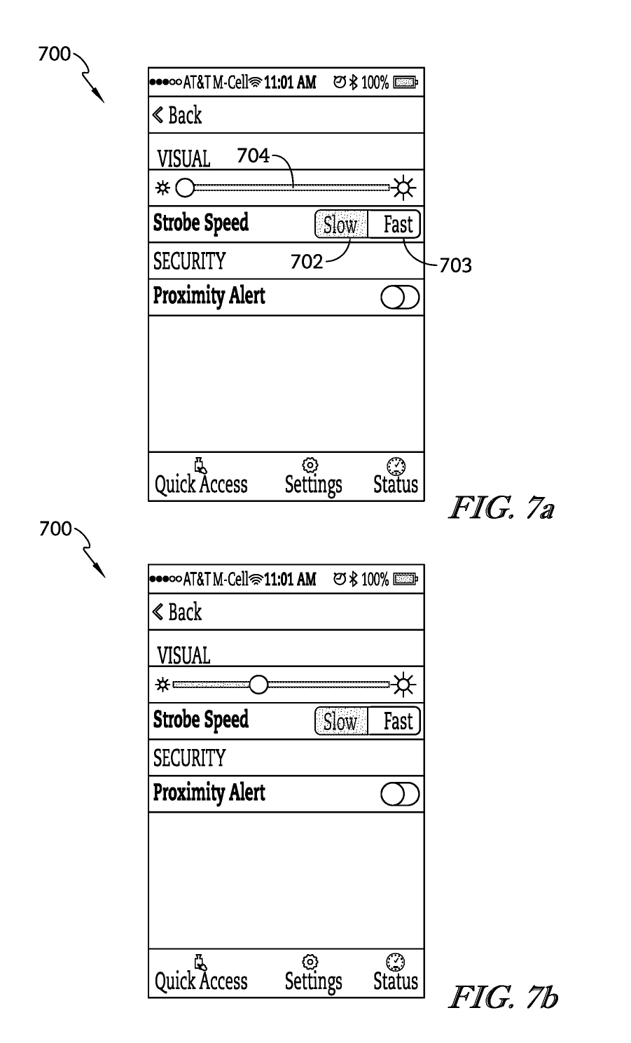

In another exemplary usage, the user 112 may instruct the control board 105 to strobe the lighting elements 104a-f, and may specify a frequency at which the lighting elements 104a-f will be strobed. The user 112 may provide a command to turn on or off strobe functionality by sliding a slide switch, selecting a radio button or check box, or other similar user input mechanism. The user 112 may select a strobe frequency by entering a number representing the desired frequency, sliding a slide bar, or other similar user input mechanism. FIGS. 7a-b show a display screen 700 provided by the software application 115 that may be presented to the user 112 having buttons 702 and 703 by which the user can select whether the strobe speed should be slow or fast.

In another exemplary usage, the user 112 may instruct the control board 105 to alter the brightness of the lighting elements 104a-f. The user 112 may provide a command indicating a desired level of brightness by entering a number representing the desired brightness, sliding a slide bar, or other similar user input mechanism. FIGS. 7a-b show a slider 704 by which the user can select a desired brightness level for the lighting elements 104a-f.

In another exemplary usage, the user 112 may instruct the control board to initiate a soft start of the lighting elements 104a-f. When initially being turned on, the lighting elements 104a-f may draw a significant amount of current that was not previously being drawn from a power source for the vehicle 102. The current draw can cause a drop in power being provisioned to other electrical componentry associated with the vehicle 102. Such a drop in power may last until the current draw of the lighting elements 104a-f levels (e.g., the lights reach a desired brightness, resulting in a steady state current draw) and/or until regulator components that process and supply power to electrical componentry have sufficient time to adjust.

To mitigate such scenarios, the user 112 may instruct the control board to initiate a soft start, in which current provisioned to the lighting elements 104a-f is slowly increased over a period of time, with the lighting elements 104a-f gradually getting brighter during that time. The user 112 may specify the period of time (e.g., 5 seconds, 10 seconds, 30 seconds, etc.).

Other manipulations of the lighting elements 104a-f are within the scope of the present disclosure. Examples may include changes to the color of the light emitted by the lighting elements 104a-f, changes to the directional orientation of the lighting elements 104a-f, or other adjustments.

Although the disclosure above was in reference to controlling and adjusting the lighting elements 104a-f, it should be understood that similar functionality can be provided on the software application 115 to control and adjust the lighting elements 106a-f, 108a-f, and 110a-f in similar fashion.

In another aspect of the present disclosure, the control board 105 may transmit information about the front light bar 104 or about the vehicle 102 to the software application 115 over the communication link 116. Such information is received and processed by the software application 115 and presented to the user 112.

In one exemplary usage, the user 112 may retrieve information about the acceleration and/or skid pad performance of the vehicle 104. As mentioned, the sensor subsystem 303 may include accelerometers and gyroscopes for sensing acceleration and motion of the control board 105. When the vehicle 102 accelerates, the accelerometers and gyroscopes may take readings that are transmitted to the microcontroller unit 302. The software application 115 may request information regarding acceleration or skid pad performance, and such request may be transmitted over the communication link 116 to the control board 105, where the request may be processed and routed to the microcontroller unit 302. The microcontroller unit 302 may service such requests, obtaining accelerometer and gyroscope readings from the sensor subsystem 303 and transmitting them to the BLUETOOTH™ low energy module 306 for transmission over the communication link 116 to the computing device 114. The software application 115 retrieves and processes the received signals, and displays the measured readings to the user 112 through a user interface. Examples of readings that the user 112 can obtain in this fashion include linear acceleration or lateral acceleration (e.g., a certain number of g's).

In another exemplary usage, the software application 115 can obtain and display speed information about the vehicle 102. The vehicle 102 may include a Global Positioning System (GPS) component (not shown) capable of tracking the positioning of the vehicle 102. The control board 105 may transmit the positioning information to the software application 115. The software application 115 may be configured to track the position of the vehicle 102 while also tracking elapsed time, and thereby compute vehicle speeds. The computed vehicle speeds may then be displayed to the user 112.

In another exemplary usage, the software application 115 can obtain and display information about the directional orientation of the vehicle 102 through digital compass functionality. The sensor subsystem 303 may include magnetometers and accelerometers, whose readings can be transmitted to the software application 115. The software application 115 can use the readings to compute a directional orientation of the vehicle 102.

In another exemplary usage, the software application 115 can obtain and display information about the altitude of the vehicle 102. As explained, the sensor subsystem 303 may include pressure sensors. Readings from the pressure sensors can be transmitted to the software application 115, where the software application 115 can use the readings to compute an altitude level for the vehicle 102.

In another exemplary usage, the software application 115 can obtain and display information regarding the operation of the lighting elements 104a-f, which can help to determine whether the lighting elements 104a-f are operational and/or to help trouble shoot the lighting elements 104a-f. The lighting elements 104a-f may be provided with voltmeters (not shown) that measure the voltage being provided to respective lighting elements 104a-f. If the user 112 observes that one or more of the lighting elements 104a-f are not operational, or if the user 112 cannot see the lighting element 104a-f and wishes to determine whether they are receiving power, the user 112 can request voltage readings. Readings taken from the voltmeters may be transmitted through the control board 105 to the software application 115. The software application 115 may then display these readings to the user 112. The user 112 may observe whether the lighting elements 104a-f are being provided with proper voltage, which may assist in trouble shooting. In similar fashion, the user 112 can obtain humidity measurements taken by sensors within the sensor subsystem 303, which can also help determine whether excess humidity is a cause of failure of the lighting elements 104a-f.

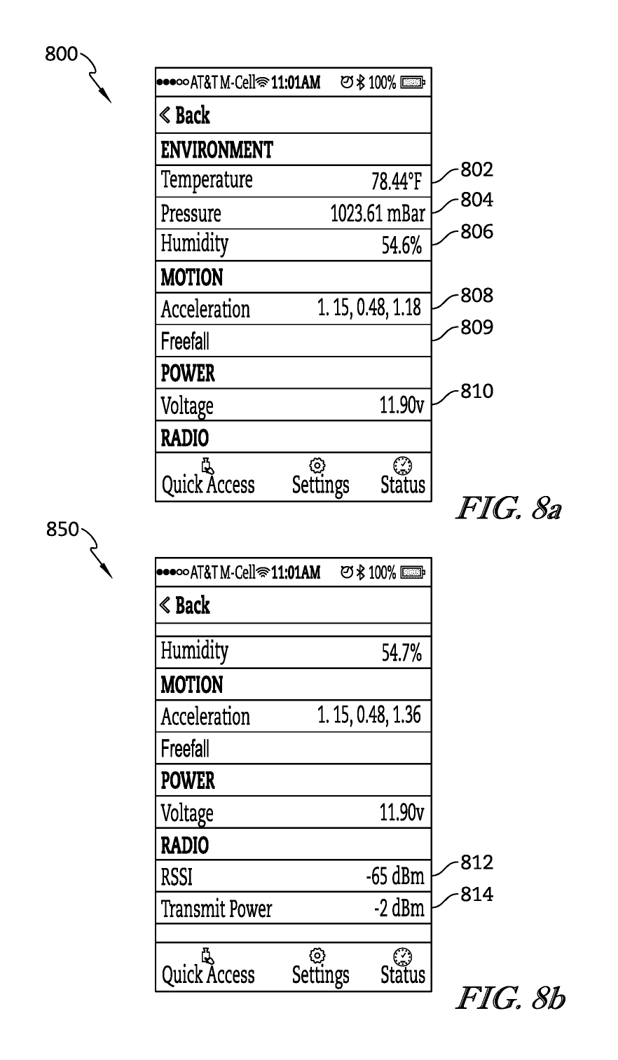

FIGS. 8a-8b show exemplary screen displays 800 and 850 that show readings that can be provided to a user in this fashion. The readings depicted in FIG. 8a include a temperature reading 802 that provides the temperature near the control board 105, a pressure reading 804 that provides the pressure near the control board 105, a humidity reading 806 that provides the humidity level near the control board 105, an acceleration reading 808 that provides three dimensions of acceleration readings for the vehicle 102, and a voltage reading 810 that provides the voltage being provided to lighting elements 104a-f. Also depicted is a freefall indicator 809, which in this example does not have a reading. FIG. 8b additionally shows an RSSI reading 812, which indicates the signal strength with which the control board 105 is receiving signals, and a transmit power reading 814 which indicates the power level with which the control module 105 is transmitting signals.

The above description was in reference to obtaining and displaying readings from the control board 105 associated with the front light bar 104, but it should be understood that similar readings may be obtained and displayed from the peripheral light bar assemblies 106 and 108 and the rear light bar assembly 110.

In another aspect of the present disclosure, the intelligent lighting system 106 may provide enhanced security and theft control features. In particular, a light bar assembly, such as the front light bar assembly 104, may be configured to be inoperable until paired in accordance with the BLUETOOTH™ specification with a BLUETOOTH™-enabled computing device using the software application 115. If a thief steals the front light bar assembly 104, the thief may be unable to use the front light bar assembly 104 until the thief obtains and installs an instance of the software application 115, and initiates a BLUETOOTH™ pairing sequence with the front light bar assembly 104. Upon doing so, the software application 115 may be able to track the location of the thief, such as by way of a GPS component located within the computing device being operated by the thief.

Thus, the user 112 may use the software application 115 to report that the front light bar assembly 104 has been stolen. The software application 115 may report information regarding the theft to a server (not shown). When the thief installs an instance of the software application 115 and pairs with the light bar assembly 104, the thief's instance of the software application 115 may report to the server that the stolen light bar assembly 104 is being activated. The server may query the thief's instance of the software application 115 to obtain location information of the thief (e.g., using GPS information provided by the thief's computing device), and report that information to user 112's instance of the software application 115, which can present the information to the user 112.

Another security feature may include a panic button. FIGS. 6a-b showed screen displays including a panic button 606. When the panic button 606 has been activated, the software application 115 may communicate to the control board 105 to take appropriate attention-getting action, such as to strobe the lighting elements 104a-f.

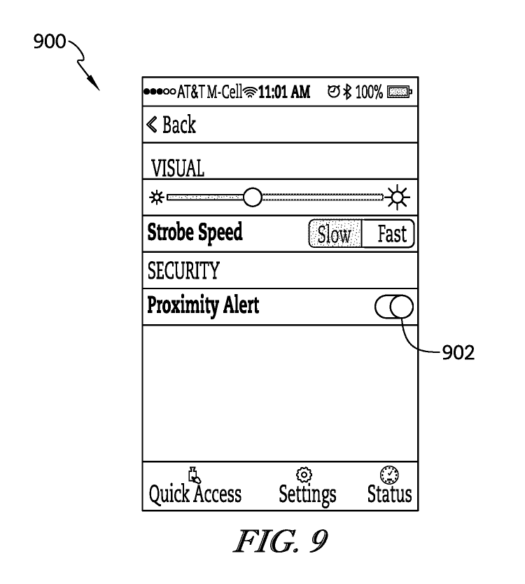

Another feature may include a proximity alert. FIG. 9 shows a screen display 900 that includes slide 902 indicating that the proximity alert has been activated. When the user 112 activates the proximity alert feature, the user 112 may be notified when the vehicle 102 is in a proximity of the user 112. The software application 115 may monitor the location of the vehicle 102, as explained above, and may compare that location to the location of the computing device 114 (obtained through, e.g., GPS functionality), and determine the distance between the user 112 and the vehicle 102.

In another aspect of the present disclosure, the intelligent light system 106 provides mesh networking functionality by which the computing device 114 need not be in direct communication with all of the light bar assemblies 104, 106, 108, and 110. Instead, the light bar assemblies 104, 106, 108, and 110 can form a mesh network and communicate amongst themselves. So long as the computing device 114 has a communication link 116 with the front light bar assembly 104, it can transmit information to and receive information indirectly from the other light bar assemblies 106, 108, and 100.

Thus, in the depicted example, the front light bar assembly 104 maintains a direct communication link 116 with the computing device 114. The front light bar assembly 104 maintains a direct communication link with the peripheral light bar assembly 106 over communication link 126, the peripheral light bar assembly 106 maintains a direct communication link with the rear light bar assembly 110 over communication link 122, and the rear light bar assembly 110 maintains a direct communication link with the peripheral light bar assembly 108 over communication link 124. The communication links 122, 124, and 126 need not operate over ranges as long as the communication link 116, and thus the control boards 107, 111, and 109 can be implemented with lower cost communication components. For example, communication links 122, 124, and 126 may be implemented with short range RF communication technologies (e.g., via RFID/NFC module 304), or may be provided with BLUETOOTH™ modules that have specifications providing for shorter ranges.

By providing mesh networking functionality among the light bar assemblies 104, 106, 108, and 110, the computing device can send or receive information, directly or indirectly, to or from any of the light bar assemblies 104, 106, 108, and 110, even without having a direct communication link to all of the light bar assemblies 104, 106, 108, and 110.

In another aspect of the present disclosure, the intelligent lighting system 106 can provide benefits to a company or organization that maintains a fleet of vehicles similar to the vehicle 102. In one exemplary usage, the intelligent lighting system 106 can collect and provide vibration data for the vehicle 102 as well as other vehicles that may be maintained by the given organization. The vibration data can be collected using accelerometers or gyroscopes which, as mentioned, can be provided as part of the sensor subsystem 303. The vibration data can be transmitted to the software application 115, where it can be analyzed and assessed by the user 112.

Such vibration data can be used for a number of purposes. For example, the vibration data can be used to test vehicle tires. The vehicle 102 can be provided with a number of different tire types, vibration data can be collected for the vehicle 102 when using each of the different tire types, the vibration data can be transmitted to the software application 115, and the vibration data can be compared to see how different tire types perform. Alternatively, an organization may maintain a fleet of vehicles, each using different tire types, and vibration information from all vehicles in the fleet can be consolidated in one location, such as in the computing device 114, for comparison and analysis. The data so collected and analyzed can assist the organization in selecting tire types that provide improved performance.

Similar testing can be done to assess and analyze different types of shocks that may be used on vehicles, and how different vehicle types operate under different load levels.

Another benefit to an organization relates to accident or “near miss” analysis. If an accident or a “near miss” is reported, the organization may wish to investigate the circumstances surrounding the accident or “near miss” to assess how its circumstances arose and how it might be prevented in the future. The data captured by the sensor subsystem 303 can be retained for a period of time, such as in a memory on the control board 105 or in a memory on the computing device 114 if such data is transmitted to the computing device 114. If an accident or “near miss” is reported, the data from the time of the accident or “near miss” can be retrieved. The organization can then analyze speed, acceleration, position, climate, humidity, and other data to analyze and better inform its understanding of the circumstances surrounding the accident or “near miss.”

Similarly, the data logged by the computing device 114 can be used to log data on a driver's driving habits, so that an organization can monitor the behavior and performance of its drivers. The software application 115 can collect the above-described types of information from the control board 105 and associate that data with respective drivers. After some period of time, the software application 115 may have data on several drivers. This data can be compared to arrive at assessments regarding which drivers are more aggressive, safer, more efficient, etc.

In another aspect of the present disclosure, the intelligent lighting system 106 allows for custom programming of the lighting elements 104a-f. The custom programming can be entered using the software application 115 and transmitted to the control board 105, where it can be programmed into a memory of the microcontroller unit 302. The microcontroller unit 302 can then operate the lighting elements 104a-f in accordance with the custom programming. Examples of custom programming may include: soft start upon turning on lighting elements (including specifications for duration of the soft start period), emitting a strobe sequence before the vehicle backs up for warning and notification purposes (including specifications for the number of strobes and frequency of strobes), custom wattage for the lighting elements 104a-f, and input voltage operation.

In another aspect of the present disclosure, the intelligent lighting system 106 can facilitate maintenance of the vehicle 102. The controller board 200 may include a counter, such as a real time clock or hour meter, that computes the number of hours of operation of the lighting elements 104a-f, which can help with assessments as to how many remaining hours there exist in the anticipated lifespan of the lighting elements 104a-f. Information on the number of hours of operation of the lighting elements 104a-f can be provided to the software application 115.

The software application 115 may be configured to issue notifications to the user 112 after certain thresholds of operational hours have been exceeded. For example, a notification may be provided when only a certain number of hours of usage are left before a warranty on the front light bar assembly 104 expires, a notification may be provided when the warranty expires, and a notification may be provided when the expected life cycle of the light bar assembly 104 elapses. This may indicate to the user 112 that the front light bar assembly 104 should be used sparingly or replaced.

In another aspect of the present disclosure, the microcontroller unit 302 may be electrically coupled to a controller area network (CAN) bus, enabling it to collect data from other electrical systems located in the vehicle 102. In particular, the microcontroller unit 302 may, over the CAN bus, collect information from other sensors or electrical componentry located throughout the vehicle 102, including information on vehicle vibration, vehicle speed, lighting failures, GPS measurements, compass readings, altimeter readings, water ingress readings, and hour meter readings, to the extent such sensors exist on the vehicle 102.

In certain embodiments, the vehicle 102 may have an on board video camera and provide video processing functionality. The video data from the on board camera can be provided to the microcontroller unit 302, from where it can be transmitted to the software application 115. The software application 115 can render the video such that the user 112, who may be at a remote location, can view the video feed.

As previously explained, certain disclosure above was made with reference to the front light bar assembly 104, but it should be understood that similar functionality can be provided in connection with the peripheral light bar assemblies 106 and 108 and the rear light bar assembly 110.

The disclosure above was provided in reference to light bars provided on a vehicle. However, systems with similar functionality may be provided in other environments, such as in or near commercial or residential buildings. Though certain aspects of the functionality described above may not necessarily be applicable to such settings, such as acceleration information, speed information, etc., other functionality can readily be applied to such settings.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation so as to encompass all such modifications and equivalent structures and functions.

What is claimed is:

1. A lighting system comprising:
a light bar having brackets to secure the light bar to an object, the light bar having a plurality of lighting elements to generate light;
a controller electrically coupled to the light bar and adapted to control functions of the light bar;
a plurality of sensors coupled to the light bar, the sensors are adapted to monitor aspects of the object to which the light bar is secured and transmit generated data to the controller.

2. The lighting system of claim 1, including a transmitter electrically coupled to the controller and adapted to transmit the data generated by the sensors.

3. The lighting system of claim 2, including a receiver electrically coupled to the controller and adapted to receive signals from an outside source, where the controller processes the received signals to control functions of the light bar.

4. The lighting system of claim 1, including a second lighting member that is independent of the light bar and controlled by the controller.

5. The lighting system of claim 1, wherein the controller is mounted remotely from the light bar.

6. The lighting system of claim 1, wherein the controller is mounted within the light bar.

7. The lighting system of claim 3, wherein the light bar functions are controlled by a remote control terminal.

8. The lighting system of claim 7, wherein the remote control terminal is an iPhone, tablet, PC machine, Windows phone, or Android phone.

9. The lighting system of claim 4, wherein the sensors are selected from the group consisting of GPS, magnetometers, and accelerometers.

10. A remote control system for controlling a lighting unit with a smart phone comprising:
programming the smart phone with an application adapted to communicate with a programmable microcontroller connected to the lighting unit to receive sensor data from the programmable microcontroller and to transmit control signals to the programmable microcontroller for controlling the lighting unit;
the light bar comprising a radio antenna adapted for communication with the smart phone
a programmable microcontroller including sensors and;
wherein the smartphone and the light bar are adapted for wireless communication.
